(19) United States
(12) Patent Application Publication
(10) Pub. No.: US 2021/0326064 A1
(43) Pub. Date: Oct. 21, 2021

(54) MEDIA TYPE SELECTION BASED ON OBJECT DISTANCE

(71) Applicant: Micron Technology, Inc., Boise, ID (US)

(72) Inventors: Bhumika Chhabra, Boise, ID (US); Zahra Hosseinimakarem, Boise, ID (US); Carla L. Christensen, Boise, ID (US)

(21) Appl. No.: 16/849,718

(22) Filed: Apr. 15, 2020

(51) Int. Cl. G06F 3/06

(52) U.S. Cl. CPC G06F 3/0659; G06F 3/068; G06F 3/0611

(57) ABSTRACT

Systems, apparatuses, and methods related to media type selection are described. Memory systems can include multiple types of memory media (e.g., volatile and/or non-volatile) and can write data to the memory media types. Data inputs can be written (e.g., stored) in a particular type of memory media based on characteristics (e.g., source, attributes, and/or information etc. included in the data). In an example, a method can include identifying an attribute of data based on a predetermined threshold distance; assigning a sensor of a plurality of sensors to capture the data based on the identified attribute; receiving, by a memory system that comprises a plurality of memory media types, the data from the assigned sensor; and selecting, based at least in part on information about the received data, one or more of the memory media types to write the data.

### TECHNICAL FIELD

The present disclosure relates generally to semiconductor memory and methods, and more particularly, to apparatuses, systems, and methods for media type selection.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAIVI), and magnetoresistive random access memory (MRAIVI), such as spin torque transfer random access memory (STT RAM), among others.

Memory devices can be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 is a functional block diagram in the form of a computing system including an apparatus including a memory system in accordance with a number of embodiments of the present disclosure.

FIG. 2 is a functional block diagram in the form of a computing system including multiple memory media types in accordance with a number of embodiments of the present disclosure.

FIG. 3 is a block diagram of a memory system method for media type selection in accordance with a number of embodiments of the present disclosure.

FIG. 4 is a flow diagram of an illustration of a method used by a memory system for media type selection in accordance with a number of embodiments of the present disclosure.

FIG. 5 is a flow diagram representing an example method for media type selection in accordance with a number of embodiments of the present disclosure.

FIG. 6 is a flow diagram representing another example method for media type selection in accordance with a number of embodiments of the present disclosure.

### DETAILED DESCRIPTION

Systems, apparatuses, and methods related to media type selection are described. Memory systems can include multiple types of memory media (e.g., volatile and/or non-volatile) and can write data to the various memory media types. The data inputs that can be written to memory media can vary based on characteristics such as source, attributes, metadata, and/or information included in the data. Data inputs received by a memory system can be written (e.g., stored) in a particular type of memory media based on information about the data. For instance, a particular memory media type can be selected from multiple tiers of memory media types based on characteristics of the memory media type and the information about the data input. Characteristics of the memory media type can include volatility, non-volatility, power usage, read/write latency, footprint, resource usage, and/or cost. In an example, a method can include identifying an attribute of data based on a predetermined threshold distance; assigning a sensor of a plurality of sensors to capture the data based on the identified attribute; receiving, by a memory system that comprises a plurality of memory media types, the data from the assigned sensor; and selecting, based at least in part on information about the received data, one or more of the memory media types to write the data.

A computing system including memory systems can include one or more different memory media types which can be used to store (e.g., write) data in a computing system. Such data can be transferred between a host associated with the computing system and the memory system. The data stored in memory media can be important or even critical to operation of the computing system and/or the host. There are various types of memory media and each type of memory media includes characteristics that may be unique to the memory media type.

For example, non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory (e.g., 3D XPoint™), resistive random access memory (RRAM), ferroelectric random access memory (FeRAM), magnetoresistive random access memory (MRAM), and programmable conductive memory, among other types of memory. Volatile memory can require power to maintain its data (e.g., host data, error data, etc.) and includes random-access memory (RAM), dynamic random access memory (DRAM), and static random access memory (SRAM), among others. The characteristics of different memory media types can include features that cause tradeoffs related to performance, storage density, energy requirements read/write speed, cost, etc. In some examples, some memory media types may be faster to read/write but less cost effective than other memory media types. In other examples, memory media types may be faster but consume a large amount of power and reduce the life of a battery, other memory media types can be slower consume less power.

As hosts such as mobile devices, semi-autonomous vehicles, fully autonomous vehicles, digital cameras, mobile artificial intelligence systems, etc. become more prevalent, sensors and other devices related to computing systems and hosts are also increasingly prevalent. The sensors can produce frequent and/or large quantities of data which can be used by a computing system, a host, and/or a user interface corresponding to a host, to make decisions related to the operation of the host. Balancing the tradeoffs between various different memory media types to store the frequent and/or large quantities of data efficiently can be an important endeavor. Particularly, when large quantities and/or frequent data inputs are generated, they require quick decisions related to an operation of a host device.

In some approaches, data may be written (e.g., stored) to a memory system based on an order in which the data arrives from an origin or by another predetermined schema and is automatically written to a particular memory media type. This approach can cause the retrieval or interpretation of the data to be slow, ineffective, costly, and/or otherwise waste resources of the computing system (e.g., host). As a result, the tradeoffs of a computing system writing data to particular memory media types can become more pronounced. Said differently, writing data according to a predetermined schema can result in non-important data occupying space in a memory media type that is better suited for important (e.g., critical) data, and critical data may be confined to a media type that is slower to access. This can lead to inefficient operation of the host and/or error in retrieving critical data from memory media on the memory system.

As mentioned, host devices can include communicatively coupled devices (e.g., sensors) which may be intermittently or consistently generating data to be written (e.g., stored) to a memory media of a memory system. As storage capability of memory systems increase, and the volume of generated data increases, and the effects of inefficient data storage becomes more pronounced. These effects can be further exacerbated by the limitations of some approaches to read and interpret data such that the contents can be effective, especially as the amount of data stored in memory systems and the speed at which data retrieval is expected.

In contrast, embodiments herein are directed to storing (e.g., writing) data generated from an host communicatively coupled to a memory system (e.g., sensors generating data) based on information about the data, a context of the host device, information included in the data, information about the data compared to a baseline, or combinations thereof. Storing (e.g., writing) data based on information can determine an appropriate memory media type to best utilize resources (e.g., power, space, cost, etc.) Using attributes, data can be assigned to the appropriate sensor. Using the data's information, a rank can be assigned to the data, and the data can be stored in a memory media type based on the rank of the data. For example, in a context of mobile devices and/or digital cameras, decisions related to data received from sensors may need to be made quickly, and latency in retrieval can be undesirable. In such examples, data requiring quick decisions may be ranked higher and written to a memory media including quick retrieval features (e.g., DRAM). In contrast, data received from a sensor that is determined not to require a quick decision can be ranked lower and stored in a memory media having a slower retrieval speed (e.g., NAND).

As used herein, the term “attribute” refers to a distance between a host and an object, whose captured image may constitute data as used herein. The distance may be measured based on a threshold distance number predetermined by a user. The threshold distance number is based on the distance between the host (including the sensors) and the object. For example, an attribute of data may refer to a distance below the threshold distance from the sensors. An attribute of data may also refer to a distance above the threshold distance from the sensors. As used herein, the terms “information about the data/ included in” and/or “information of the data” refers to the contents of the data (e.g., metadata such as time, date, GPS location, etc.), or a context of the host corresponding to the sensor generating the data (e.g., a sensor on a mobile device being a certain distance from the object captured within the data). For example, information about the data can refer to the quantity (e.g. size and number) and quality (e.g. clarity) of the data to be stored in the memory media. In other words, information about the data can refer to a characteristic of the data (e.g., how large the data file maybe or how many files exist within the data file a location on the host or positional information). The information about the data can be compared to baseline information, and the comparison can be used to determine which memory media type should be used to store the data.

The selection of a memory media type from a multiple memory media types, of which to store the data received, can be made by a memory system controller and/or a host controller. A memory system controller can be a controller or other circuitry which is coupled to the memory system. The memory system controller can include hardware, firmware, and/or software to determine attributes and information about the incoming data and select a memory media type to write the data. A host controller can be a controller or other circuitry which can be communicatively coupled to the memory system to determine attributes and information about the incoming data and select a memory media type to write the data.

Embodiments herein can allow a memory system including multiple memory media types to selectively determine which memory media type is appropriate for the incoming data, based at least in part, a context of the host, information included in the data, a comparison of the data to baseline data, or a combination thereof.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

As used herein, designators such as “J,” “K,” “L,” “N,” “R,” “Q,” etc., particularly with respect to reference numerals in the drawings, indicate that a number of the particular feature so designation can be included. It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

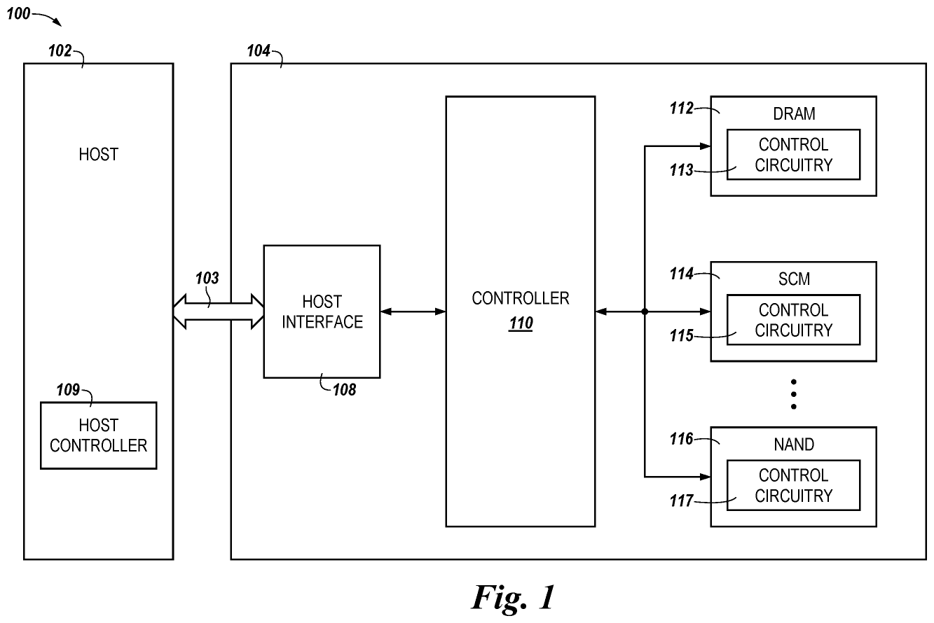

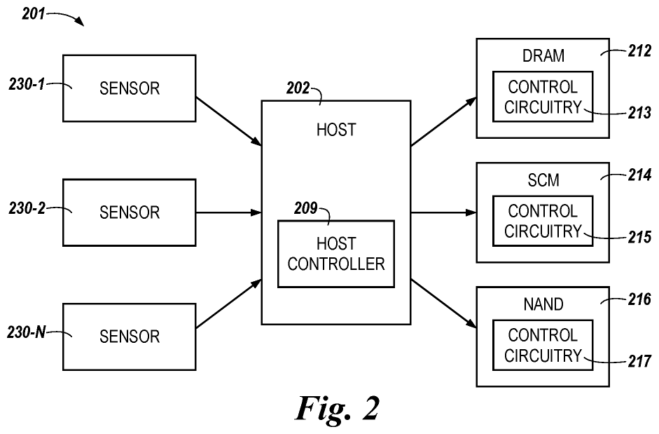

The figures herein follow a numbering convention in which the first digit or digits correspond to the figure number and the remaining digits identify an element or component in the figure. Similar elements or components between different figures can be identified by the use of similar digits. For example, 109 can reference element “09” in FIG. 1, and a similar element can be referenced as 209 in FIG. 2. A group or plurality of similar elements or components can generally be referred to herein with a single element number. For example, a plurality of reference elements 230-1, . . . 230-N (e.g., 230-1 to 230-P) can be referred to generally as 230. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional block diagram in the form of a computing system 100 including an apparatus including a memory system 104 in accordance with a number of embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. The memory system 104 can include a host interface 108, a controller 110, e.g., a processor, control circuitry, hardware, firmware, and/or software and a number of memory media devices each including control circuitry.

FIG. 1 illustrates a non-limiting example of multiple memory media types in the form of a DRAM 112 including control circuitry 113, SCM 114 including control circuitry 115, and a NAND 116 including control circuitry 117. While three memory media types (e.g., DRAM 112, SCM 114, and NAND 116) are illustrated, embodiments are not so limited, however, and there can be more or less than three memory media types. Further, the types of memory media are not limited to the three specifically illustrated (e.g., DRAM 112, SCM 114, and NAND 116) in FIG. 1, other types of volatile and/or non-volatile memory media types are contemplated. In a number of embodiments, the controller 110, the memory media DRAM 112, SCM, 114, and NAND 116, and/or the host interface 108 can be physically located on a single die or within a single package, e.g., a managed memory application. Also, in a number of embodiments, a memory, e.g., memory media DRAM 112, SCM, 114, and NAND 116, can be included on a single memory system 104.

As illustrated in FIG. 1, the controller 110 can be coupled to the host interface 108 and to the memory media DRAM 112, SCM, 114, and NAND 116 via one or more channels and can be used to transfer data between the memory system 104 and a host 102 having a host controller 109. The host interface 108 can be in the form of a standardized interface. For example, when the memory system 104 is used for data storage in a computing system 100, the interface 108 can be a serial advanced technology attachment (SATA), peripheral component interconnect express (PCIe), or a universal serial bus (USB), a double data rate (DDR) interface, among other connectors and interfaces. In general, however, interface 108 can provide an interface for passing control, address, data, and other signals between the memory system 104 and a host 102 having compatible receptors for the host interface 108.

The host 102 can be a host system such as a personal laptop computer, a vehicle, a desktop computer, a digital camera, a mobile telephone, an internet-of-things (IoT) enabled device, or a memory card reader, graphics processing unit (e.g., a video card), among various other types of hosts. The host 102 can include a system motherboard and/or backplane and can include a number of memory access devices, e.g., a number of processing resources (e.g., one or more processors, microprocessors, or some other type of controlling circuitry). One of ordinary skill in the art will appreciate that “a processor” can intend one or more processors, such as a parallel processing system, a number of coprocessors, etc. The host 102 can be coupled to a host interface 108 of the memory system 104 by a communication channel 103.

As used herein an “IoT enabled device” can refer to devices embedded with electronics, software, sensors, actuators, and/or network connectivity which enable such devices to connect to a network and/or exchange data. Examples of IoT enabled devices include mobile phones, smart phones, tablets, phablets, computing devices, implantable devices, vehicles, home appliances, digital cameras, smart home devices, monitoring devices, wearable devices, devices enabling intelligent shopping systems, among other cyber-physical systems.

In some embodiments, the host 102 can be responsible for executing an operating system for a computing system 100 that includes the memory system 104. Accordingly, in some embodiments, the host 102 can be responsible for controlling operation of the memory system 104. For example, the host 102 can execute instructions (e.g., in the form of an operating system) that manage the hardware of the computing system 100 such as scheduling tasks, executing applications, controlling peripherals, etc.

The computing system 100 can include separate integrated circuits or the host 102, the memory system 104, the host interface 108, the controller 110, and/or the memory media DRAM 112, SCM, 114, and/or NAND 116 can be on the same integrated circuit. The computing system 100 can be, for instance, a server system and/or a high-performance computing (HPC) system and/or a portion thereof. Although the example shown in FIG. 1 illustrate a system having a Von Neumann architecture, embodiments of the present disclosure can be implemented in non-Von Neumann architectures, which may not include one or more components (e.g., CPU, ALU, etc.) often associated with a Von Neumann architecture.

Although not illustrated in FIG. 1 as to not obscure the examples of the disclosure, the memory system 104 can be communicatively coupled (e.g., connected) to sensors which can be communicatively coupled to the host 102. The term “coupled” means directly or indirectly connected and, unless stated otherwise, can include a wireless connection. As used herein, the term “sensor” refers to a device that can generate and send data and/or receive data. Some examples of sensors can include temperature devices, camera devices, video devices, audio devices, motion devices, Internet of Things (IoT) enabled devices (e.g., vehicle electronic control unit (ECU) devices, lens, thermostats, bulbs, locks, security systems, toothbrushes, pet feeders, etc.), among others. The sensors may transmit data for storage in the memory system 104. For example, the controller 110 can be coupled to a plurality of memory media types (e.g., the memory media DRAM 112, SCM, 114, and NAND 116) to receive data from the plurality of sensors.

The controller 110 (and/or the host controller 109) can receive data multiple times from an individual sensor, or from multiple sensors. The sensors may have multiple functionalities and transmit data having more than one type of information. For example, one or more of the sensors can include acoustic (e.g., a microphone, etc.) functionality, video functionality, or both and be communicatively coupled to the host 102. The controller 110 can determine the attribute of the data and identify information about the data. For example, the controller 110 can determine the distance between the host 102 and the object to be captured. In another example, the controller 110 can identify a particular sensor that transmitted the data, the contents of the data, an operation of the host 102 at the time the data was transmitted, etc. The controller 110 can select, based at least in part on information about the data, a memory media type of the plurality of memory media types (e.g., memory media DRAM 112, SCM, 114, and NAND 116) and write the data to the selected memory media type. Further, the memory media types (e.g., memory media DRAM 112, SCM, 114, and NAND 116) can be communicatively coupled to each other such that data can be transferred between the memory media.

The selection of the memory media type can be based in part on a rank assigned to the data by the controller 110. The assigned rank can be based at least in part on the information about the data within a context of the host. In some examples, the context can be an operation of the host. For example, in some embodiments, the host 102 can be a mobile device and the information included in the data are related to a size, clarity and number of data received by each of a plurality of sensors (e.g. lens) respective to the host 102 (e.g., the mobile device) communicatively coupled to the controller 110. For example, the higher data is ranked, the faster it may need to be accessed by the computing system 100.

In one embodiment, an object may be assigned to a sensor of a plurality of sensors based on the distance between the host 102 and the object. The assigned sensor may send the data received from the object to the controller 110. The data may be an image of the object. Data having better clarity or below a threshold number may be ranked higher than bulky data or unreadable, unclear data. In some embodiments, the threshold number and clarity may be predetermined by a user. The higher ranked data may be written into the DRAM 112 because it is faster than other types of memory media. That is, the data with better clarity or below a threshold size (e.g. pixels or bytes) may be written into the DRAM 112 because it is faster than the other types of memory media. In some embodiments, higher ranked data may be automatically written into its selected memory media type by the controller 110.

The lower ranked data may be written to the SCM 114 or the NAND 116 because it is not as relevant to the context (e.g., efficient processing) of the host 102 (e.g., the mobile device) and thus ranked lower. That is, the bulky, unclear or distorted data or above a predetermined size (e.g. pixels or bytes) may be written to the SCM 114 or the NAND 116 because it is ranked lower as it not as relevant to the context (e.g., efficient processing) of the host 102 (e.g., the mobile device). In some examples, the controller 110 can compare the received data to reference data related to the sensor.

For example, the controller 110 may receive data from a sensor of the plurality of sensors coupled to the host 102. The controller can compare the received data from the sensor to reference data (corresponding to the same sensor) stored by a memory media type (e.g., SCM 114 or NAND 116). The controller 110 can identify differences between the received data and the reference data and assign a rank to the received data based at least in part on the identified differences. An indication of differences in the received data and the reference data can indicate that the received data should be stored in a memory media type that is quickly accessible (e.g., DRAM 112). In contrast, when no differences between the received data and the reference data are identified, the controller 110 may store the received data in a memory type that is not as quickly accessible.

For example, the controller 110 can write the received data in a first memory media type (e.g., DRAM 112) of the plurality of memory media types (e.g., memory media DRAM 112, SCM, 114, and NAND 116) responsive to the comparison indicating differences between the received data and the reference data. In contrast, the controller 110 can write the received data in a second memory media type (e.g., SCM 114 or NAND 116) of the plurality of memory media types (e.g., memory media DRAM 112, SCM, 114, and NAND 116) responsive to the comparison indicating that the received data and the reference data is the same, where the first memory media type is volatile and can be accessed quickly, and the second memory media type is non-volatile and may be slower to access.

FIG. 2 is a functional block diagram in the form of a computing system 201 including multiple memory media types in accordance with a number of embodiments of the present disclosure. FIG. 2 illustrates a computing system 201 which includes a host 202, including a host controller 209 which can be analogous to the host 102 and host controller 109 described in connection with FIG. 1. Although not illustrated in FIG. 2 as to not obstruct the examples of the disclosure, computing system 201 can include a controller (e.g., controller 110 described in connection with FIG. 1). The computing system 201 can include sensors 230-1, 230-2, and 230-N, which may be generally referred to herein as the sensors 230.

The host 202 can be communicatively coupled to the sensors 230 via a physical connection (e.g., via wiring, circuitry, etc.) or remotely coupled (e.g., via a wireless signal, near field communication, Bluetooth, Bluetooth Low Energy, RFID, etc.). The host 202 can be communicatively coupled to one or more memory media types. FIG. 2 illustrates a non-limiting example of multiple memory media types in the form of a DRAM 212 including control circuitry 213, SCM 214 including control circuitry 215, and a NAND 216 including control circuitry 217. The host 202 can receive data generated from one or more of the sensors 230.

The embodiment illustrated in FIG. 2 illustrates an example of the sensors 230 transmitting data to the host 202 having a host controller 209, where the host controller 209 receives data from one or more of the sensors 230 and determines a rank of the data received. Based on the determined rank, the host controller 209 can determine which memory media type (e.g., DRAM 212, SCM 214, and/or NAND 216) is the most appropriate to write the data to. Embodiments described in connection with FIG. 2 are not so limited, however, examples described in connection with FIG. 2 can be accomplished with a memory system controller analogous to the controller 110 of FIG. 1.

The host controller 209 can receive data from at least one sensor of the sensors 209, identify an attribute about the data, identify information about the data, and select one or more of the memory media types (e.g., DRAM 212, SCM 214, and/or NAND 216) to write the data to, based on information about the data. For example, the host controller 209 can receive data from a first sensor 230-1 of the plurality of sensors 230 and identify an attribute of the data to determine assignment of the first sensor 230-1. Information about the data received from the first sensor 230-1 can be a type of sensor or a location of the sensor 230-1 relative to the host 202 (e.g., data received from a camera sensor). Information about the data from the first sensor 230-1 can include a time received, images captured from the first sensor 230-1, etc.

The host controller 209 can receive data from any of the sensors 230 separately or concurrently. For example, the host controller 209 can receive data from a second sensor 230-2 of the plurality of sensors 230, separately or concurrent with the data received from the first sensor 230-1, and identify information about the data from the second sensor 230-2. Information about the data received from the second sensor 230-2 can be a type of sensor or a location of the sensor 230-2 relative to the host 202 (e.g., data received from a camera sensor). Information about the data can include metrics such as can include a time received, images captured from the second sensor 230-2, etc. The host controller 209 can determine a rank of the data received from the first sensor 230-1 and the data received from the second sensor 230-2.

For example, the host controller 209 can determine, based on the identified information about the data from the first sensor 230-1 and the second sensor 230-2, a rank of the information corresponding to the first sensor 230-1 and the second sensor 230-2. In embodiments herein, the ranking can be dependent in part on a context of the host 202. The host controller 209 can determine a memory media type to store the data based at least in part on the rank.

For example, the host controller 209 can select the memory media type (e.g., DRAM 212, SCM 214, and/or NAND 216) to write the data from the first sensor 230-1 and the second sensor 230-2, where the memory media type selected depends on the determined rank of the information corresponding to the first sensor 230-1 and the second sensor 230-2. Specifically, the host controller 209 can store the data having the higher rank in memory media that has characteristics related to fast accessibility (e.g., DRAM 212) because the higher ranked data is more important to the context of the host 202. In other embodiments, the host controller 209 can receive more than one portion of data from an individual sensor 230.

The host controller 209 can receive a first portion of data from a sensor 230-N of the plurality of sensors 230 and identify information about the first portion of data from the sensor 230-N. In this example, the attributes of the sensor 230-N can be a type and location of the sensor 230-N relative to the host 202 (e.g., a video sensor), while information about the data can include such metrics as a time the first portion of data was captured, images included in the first portion of data, etc. The host controller 209 can receive a subsequent portion of data from the sensor 230-N.

For example, the host controller 209 can receive a subsequent portion of data from the sensor 230-N and identify information about the subsequent portion of data from the sensor 230-N. In this example, information about the data can be the same information about the data corresponding to the first portion of data (e.g., a video sensor) because the first portion of data and the subsequent portion of data were generated by the same sensor 230-N. However, the information about the subsequent portion of data may be different from the first potion of data. For example, the information of the subsequent portion of data may include images that were captured at a different time, or the host 202 (e.g., the camera) may have changed a context. The host controller 209 can rank the first portion of data and the second portion of data based on the information included in the data from the sensor 230-N that generated the data.

Continuing with the previous example, the host controller 209 can determine, based on the identified information about the first portion of data and the subsequent portion of data received from the sensor 230-N, a rank of the first portion of data and the subsequent portion of data. The first portion of data the subsequent portion of data can be the same or different. The host controller 209 can select the memory media type (e.g., DRAM 212, SCM 214, and/or NAND 216) to write the first portion of data and the subsequent portion of data from the sensor 230-N, where the memory media type selected depends on the determined rank of the information corresponding to the first portion of data and the subsequent portion of data.

For example, the host controller 209 can select a first memory media type DRAM 212 to write a first portion of data received from sensor 230-N and select a second memory media type SCM 214 to write the subsequent portion of data received from the sensor 230-N, where the first memory media type DRAM 212 and the second memory media type SCM 214 are different and selected based on a determined rank of the first and the subsequent portions of the data. In other words, the portion of the data that is determined to be the highest ranked (e.g., the most important or most relevant to the host 202) can be stored in a place that is more quickly accessible (e.g., DRAM 212) and the lower ranked (e.g., not relevant or important to the host 202) can be stored in a memory of a memory media that is slower to access (e.g., SCM 214 or NAND 216).

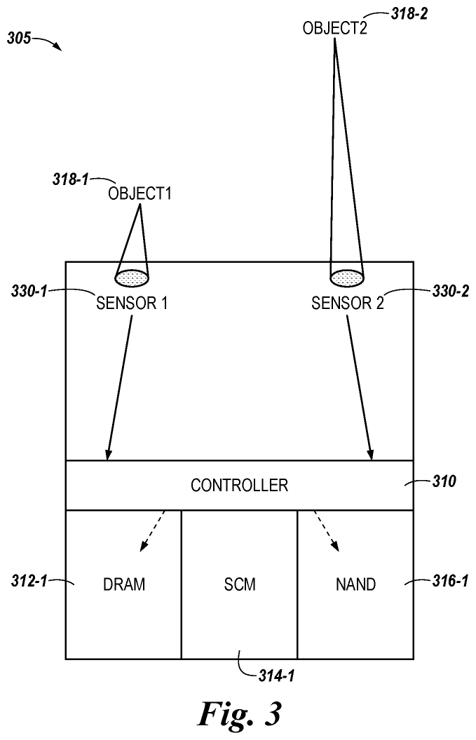

FIG. 3 is a block diagram of a memory system method 305 for media type selection in accordance with a number of embodiments of the present disclosure. The host 302 (e.g., host 102 in FIG. 1) can include a controller 310 which can be analogous to the controller 110 respectively described in connection with FIG. 1. The controller 310 can be communicatively coupled to sensors 330-1 and 330-2, which can be generally referred to as the sensors 330 and be analogous to sensors 230 described in connection with FIG. 2. While two sensors (Sensor1 330-1 and Sensor2 330-2) are illustrated, embodiments are not so limited, however, and there can be more or less than two sensors. The controller 310 can be communicatively coupled to multiple memory media types. The memory media types can include a DRAM 312-1, a SCM 314-1, and a NAND 316. Embodiments are not so limited, however, and memory system can include any number or combination of memory media types (e.g., non-volatile and/or volatile).

An example host may be a mobile device or a digital camera. The sensor of the multiple of sensors on the host may be assigned to capture data based on the data's attribute. The sensor may be assigned based on the distance between the object and the sensor. The distance may be measured based on a threshold number predetermined by a user. Object1 318-1 may represent an object at a distance below the threshold distance from the sensors. Object2 318-2 may represent an object at a distance above the threshold distance from the sensors.

A sensor may be assigned to capture objects at a distance below the threshold distance while another may be assigned to capture objects at a distance above the threshold distance. Sensor1 330-1 may be assigned to capture objects at a distance below the threshold distance. As such, as illustrated in FIG. 3, Sensor1 330-1 may be assigned to capture Object1 318-1, located at a distance below the threshold distance. Sensor2 330-2 may be assigned to capture objects at a distance above the threshold distance. As such, as illustrated in FIG. 3, Sensor2 330-2 may be assigned to capture Object2 318-2, located at a distance above the threshold distance.

The captured data may be sent to the controller 310. The controller 310 may receive the data sent by the sensors 330. The controller 310 can selectively determine which memory media type (e.g., memory media DRAM 312-1, SCM, 314-1, and NAND 316-1) is appropriate for the incoming data, based at least in part, on a context of the host, information included in the data, a comparison of the data to baseline data, or a combination thereof. The controller 310 can determine where to send the data. The selection of the memory media type can be based in part on a rank assigned to the data by the controller 310. The assigned rank can be based at least in part on the information about the data and/or the context of the host.

The controller 310 can compare the received data from the sensor to reference data stored by a memory media type (e.g., memory media DRAM 312-1, SCM, 314-1, and NAND 316-1). The controller 310 may assign the data to a memory media type based in part on a rank assigned to the data. The rank may be based on the comparison of the received data and the reference data. The controller 310 can select, based at least in part on the identified information about the data, a memory media type of the plurality of memory media types (e.g., memory media DRAM 312-1, SCM, 314-1, and NAND 316-1).

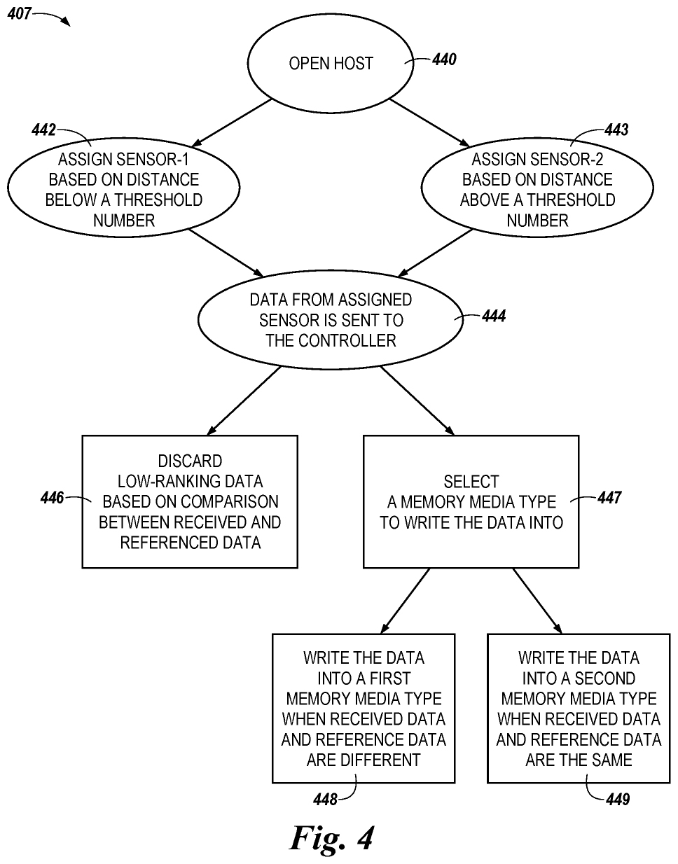

FIG. 4 is a flow diagram of an illustration of a method 407 used by a memory system for media type selection in accordance with a number of embodiments of the present disclosure. At block 440, the method 407 may include opening up the host (e.g. host 102 in FIG. 1). The host may be a host system such as a personal laptop computer, a vehicle, a desktop computer, a digital camera, a mobile telephone, an internet-of-things (IoT) enabled device, or a memory card reader, graphics processing unit (e.g., a video card), among various other types of hosts. The host 102 can include a system motherboard and/or backplane and can include a number of memory access devices, e.g., a number of processing resources (e.g., one or more processors, microprocessors, or some other type of controlling circuitry).

At block 442, the method 407 may include assigning a sensor (e.g. sensor 230-1 of FIG. 2) of the plurality of sensors (e.g. sensors 230 of FIG. 2) to capture data based on a distance below a threshold number. The data may be an image of an object. The threshold distance may be predetermined by a user. Data may be assigned to a sensor based on the threshold distance. The host controller (e.g. host controller 109 from FIG. 1) may compare the distance of the object to the assigned sensor and the predetermined threshold distance. Distances below the predetermined threshold distance may be assigned to a consistent sensor of the plurality of sensors.

At block 443, the method 407 may include assigning a sensor (e.g. sensor 230-1 of FIG. 2) of the plurality of sensors (e.g. sensors 230 of FIG. 2) to capture data based on a distance above a threshold number. The data may be an image of an object. The threshold distance may be predetermined by a user. Data may be assigned to a sensor based on the threshold distance. The host controller (e.g. host controller 109 from FIG. 1) may compare the distance of the object to the assigned sensor and the predetermined threshold distance. Distances above the predetermined threshold distance may be assigned to a consistent sensor of the plurality of sensors. The sensor assigned for data at a distance below the threshold distance may be different from the sensor assigned for data at a distance above the threshold distance.

At block 444, the method 407 may include sending data from the assigned sensor (e.g. sensor 230-1 of FIG. 2) to the controller (e.g., the controller 110 described in connection with FIG. 1). The controller can selectively determine which memory media type (e.g., memory media DRAM 112, SCM, 114, and NAND 116) is appropriate for the incoming data, based at least in part, a context of the host, information included in the data, a comparison of the data to baseline data, or a combination thereof. The controller can determine where to send the data. The selection of the memory media type (e.g., memory media DRAM 112, SCM, 114, and NAND 116) can be based in part on a rank assigned to the data by the controller. The assigned rank can be based at least in part on the information about the data and/or a context of the host.

At block 446, the method 407 may include discarding low ranking data based on a comparison between received data and referenced data. The controller (e.g., controller 110 of FIG. 1) can compare the received data from the sensor to reference data (corresponding to the same sensor) stored by a memory media type (e.g., memory media DRAM 112, SCM, 114, and NAND 116). The controller may assign the data to a memory media type based in part on a rank assigned to the data. The assigned rank can be based at least in part on the information about the data and/or a context of the host. Data having better clarity or below a threshold number may be ranked higher than bulky data or unreadable, unclear data.-Lower ranked data may be discarded and not stored if the controller determines that the data is sufficiently irrelevant. The controller may determine relevance based on predetermined preferences supplied by a user.

At block 447, the method 407 may include selecting a memory media type (e.g., memory media DRAM 112, SCM 114, and NAND 116) to write the data into. The controller (e.g., controller 110 of FIG. 1) can compare the received data from the sensor to reference data (corresponding to the same sensor) stored by a memory media type (e.g., memory media DRAM 112, SCM 114, and NAND 116). The controller may assign the data to a memory media type based in part on a rank assigned to the data. The assigned rank can be based at least in part on the information about the data and/or within a context of the host. The controller can select, based at least in part on the identified information about the data, a memory media type of the plurality of memory media types (e.g., memory media DRAM 112, SCM 114, and NAND 116).

At block 448, the method 407 may include writing the data into a memory media type (e.g., memory media DRAM 112, SCM 114, and NAND 116) when the received data and reference data are different. The controller (e.g., controller 110 of FIG. 1) can identify differences between the received data and the reference data and assign a rank to the received data based at least in part on the identified differences. An indication of differences in the received data and the reference data can indicate that the received data should be stored in a memory media type that is quickly accessible (e.g., DRAM 112).

At block 449, the method 407 may include writing the data into a memory media type (e.g., memory media DRAM 112, SCM 114, and NAND 116) when the received data and reference data are the same. The controller (e.g., controller 110 of FIG. 1) can identify differences between the received data and the reference data and assign a rank to the received data. When no differences between the received data and the reference data are identified, the controller may store the received data in a memory type that is not as quickly accessible (e.g., SCM 114 or NAND 116).

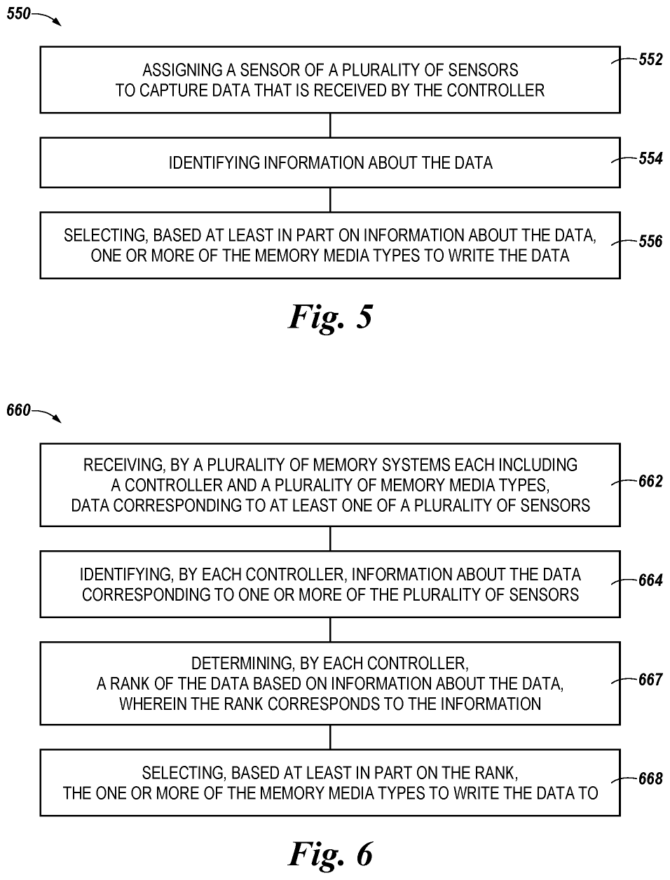

FIG. 5 is a flow diagram representing an example method 550 for media type selection in accordance with a number of embodiments of the present disclosure. At block 552, the method 550 can include assigning a sensor of a plurality of sensors (e.g., sensors 230 described in connection with FIG. 2) to capture data that is received by the controller (e.g., the controller 110 described in connection with FIG. 1) . The sensors may have multiple functionalities and transmit data having more than one type of information. For example, one or more of the sensors can include acoustic (e.g., a microphone, etc.) functionality, video functionality, or both and be communicatively coupled to a host (e.g., the host 102 described in connection with FIG. 1). The sensors can be generating information.

At block 554, the method 550 can include identifying information about the data. For example, information about the data can refer to metrics of the data. Information about the data can also refer to the quantity (e.g. size and number) and quality (e.g. clarity) of the data to be stored in the memory media. In other words, information about the data can refer to a characteristic of the data (e.g., how large the data file maybe or how many files exist within the data file a location on the host or positional information).

At block 556, the method 550 can include selecting, based at least in part on information about the data, one or more of the memory media types (e.g., DRAM 112, SCM 114, and/or NAND 116 described in connection with FIG. 1), to write the data. The selection of a memory media type from a plurality of memory media types, of which to store the data received, can be made by a memory system controller (e.g., the controller 110 and/or a host controller 109 described in connection with FIG. 1). The controller can rank the data as described herein in connection with FIGS. 1-5 and select a memory device to store the data based on the determined rank.

FIG. 6 is a flow diagram representing another example method 660 for media type selection in accordance with a number of embodiments of the present disclosure. At block 662, the method 660 can include receiving, by a plurality of memory systems each including a controller (e.g., the controller 110 described in connection with FIG. 1) and a plurality of memory media types (e.g., DRAM 112, SCM 114, and/or NAND 116 described in connection with FIG. 1), data corresponding to at least one of a plurality of sensors .

At block 664, the method 660 can include identifying, by each controller, information about the data corresponding to one or more of the plurality of sensors. For example, information about the data can refer to a device (e.g., sensor) or a type of device (e.g., a camera) that generated the data to be stored in the memory media. In other words, information about the data can refer to a characteristic of the device (e.g., sensor) that generated the data (e.g., a location on the host or positional information).

At block 667, the method 660 can include determining, by each controller, a rank of the data based on information about the data, wherein the rank corresponds to information about the data. For example, a rank can be assigned to the data based on information included in the data from the sensor that generated the data, and the data can be stored in a memory media type based on the rank of the data. Data requiring quick decisions may be ranked higher and written to a memory media including quick retrieval features (e.g., DRAM). In contrast, data received from a sensor that is determined not to require a quick decision can be ranked lower and stored in a memory media having a slower retrieval speed (e.g., NAND).

At block 668, the method 660 can include selecting, based at least in part on the rank, the one or more of the memory media types to write the data. The controller can selectively determine which memory media type is appropriate for the incoming data, based at least in part, a context of the host, information included in the data, a comparison of the data to baseline data, or a combination thereof. In some embodiments, the ranking of data can be dependent, at least in part on the context (e.g., the operation) of the host as determined by the operation of the memory systems.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method, comprising:
identifying an attribute of data based on a threshold distance;
assigning a sensor of a plurality of sensors to capture the data based on the threshold distance as the identified attribute;
receiving, by a memory system that comprises a plurality of memory media types, the data from the assigned sensor; and
selecting, based at least in part on information about the received data, one or more of the memory media types to write the data.

2. The method of claim 1, further comprising:
comparing the received data from the at least one sensors to reference data stored in a memory of the plurality of memory media types;
identifying a difference between the received data and the reference data; and
assigning a rank to the received data based at least in part on the identified difference.

3. The method of claim 2, comprising:
writing the received data in a first memory media type of the plurality of memory media types responsive to the comparison indicating the difference between the received data and reference data; and
writing the received data in a second memory media type of the plurality of memory media types responsive to the comparison indicating that the received data and the reference data is the same, wherein the first memory media type is volatile, and the second memory media type is non-volatile.

4. The method of claim 1, comprising:
determining, based on the information of a first portion of data and a subsequent portion of data received from the sensor, a rank of the first portion of data and the subsequent portion of data; and
selecting the memory media type to write the first portion of data and the subsequent portion of data from the sensor, wherein the memory media type selected depends on the determined rank of the information corresponding to the first portion of data and the subsequent portion of data.

5. The method of claim 4, comprising:
determining information about the data, wherein the information is related to a function of the at least one of the plurality of sensors and the information is related to an image included in the data; and
determining a rank of the data based at least in part on the image and the function of the sensor.

6. The method of claim 5, further comprising discarding the data based on the assigned rank and the operation of the plurality of memory systems.

7. The method of claim 1, comprising:
determining, based on the identified attribute from a first sensor and a second sensor, a rank of the information corresponding to the first sensor and the second sensor; and
selecting the memory media type to write the data from the first sensor and the data from the second sensor, wherein the memory media type selected depends on the determined rank of the information corresponding to the first sensor and the second sensor.

8. The method of claim 1, comprising:
selecting a first memory media type to write a first portion of data received from the at least one of the plurality of sensors; and
selecting a second memory media type to write a subsequent portion of data received from the at least one of the plurality of sensors, wherein the first memory media type and the second memory media type are different and selected based on a determined rank of the first and the subsequent portions of the data.

9. The method of claim 1, comprising:
determining, by each controller, a first operation of the plurality of memory systems;
receiving an initial portion of data from a sensor of the plurality of sensors during the first operation of the plurality of memory systems;
assigning an initial rank corresponding to the initial portion of data, wherein the initial rank is assigned based on the first operation of the plurality of memory systems and information about the initial portion of data; and
selecting a first memory media type to write the initial portion of data based on the assigned initial rank.

10. The method of claim 1, comprising:
determining, by each controller, a subsequent operation of the plurality of memory systems;
updating the initial rank corresponding to an initial portion of data, wherein the updated rank is assigned based on the subsequent operation of the plurality of memory systems and information about the initial portion of data; and
transferring the initial portion of data to a second memory media type based on the updated rank and the subsequent operation of the plurality of memory systems.

11. A system, comprising:
a plurality of sensors to detect an object; and
one or more memory systems, each communicatively coupled to the plurality of sensors, wherein each of the one or more memory systems comprises a controller coupled to a plurality of memory media types, each of the controllers configured to:
identify at least one sensor of the plurality of sensors communicatively coupled to the one or more memory systems to capture data, based on a threshold distance as an attribute of the data;
receive the data from the identified sensor;
compare information about the received data to reference data corresponding to the plurality of sensors;
select, based on the comparison of the information, a memory media type of the plurality of memory media types; and
write the data into the selected memory media type.

12. The system of claim 11, wherein:
the plurality of sensors includes a plurality of lens on a camera designated based on distance.

13. The system of claim 12, wherein a sensor of the plurality of sensors is chosen based on the distance of the sensor to the object.

14. The system of claim 11, wherein the memory media type selected is volatile memory responsive to the determination by the controller that the reference data and the received data are different.

15. The system of claim 11, wherein the memory media type selected is non-volatile responsive to the determination by the controller that the reference data and the received data are the same.

16. An apparatus, comprising:
a plurality of memory media types; and
a controller coupled to the plurality of memory media types, wherein the controller is configured to:
identify an attribute of data based on a threshold distance;
assign a sensor of a plurality of sensors to capture the data based on the threshold distance as the identified attribute;
receive the data from the assigned sensor;
select, based at least in part on ranking information about the data, a memory media type of the plurality of memory media types; and
write the data into the selected memory media type.

17. The apparatus of claim 16, wherein the plurality of sensors include a plurality of lens.

18. The apparatus of claim 16, wherein the plurality of sensors are communicatively coupled to a host.

19. The apparatus of claim 16, wherein the attribute is based on the predetermined threshold distance of the data.

20. The apparatus of claim 16, wherein the plurality of memory media types comprise at least one of Dynamic Random-Access Memory (DRAM), Storage Class Memory, or NAND, or any combinations thereof.
